(19) United States
(12) Patent Application Publication
(10) Pub. No.: US 2026/0304310 A1
(43) Pub. Date: Oct. 1, 2026

(54) METHODS AND APPARATUS FOR JOINT FRONTHAUL QUANTIZATION AND COMPRESSION OPTIMIZER (JFQCO) FOR ENERGY EFFICIENT O-RAN IN A WIRELESS COMMUNICATION SYSTEM

(71) Applicant: Samsung Electronics Co., Ltd., Suwon-si, Gyeonggi-do (KR)

(72) Inventors: Mutasem HAMDAN, Staines (GB); Manijeh BASHAR, Staines (GB)

(21) Appl. No.: 19/479,711

(22) PCT Filed: Apr. 15, 2024
(86) PCT No.: PCT/KR2024/095739

§ 371 Date: Oct. 28, 2025

(30) Foreign Application Priority Data
Apr. 28, 2023 (GB) 2306335.7
Mar. 28, 2024 (GB) 2404501.5

(51) Int. Cl. H04W 52/02; H04W 28/06

(52) U.S. Cl. CPC H04W 52/0203; H04W 28/06

(57) ABSTRACT

The present disclosure relates to a 5G communication system or a 6G communication system for supporting higher data rates beyond a 4G communication system such as long term evolution (LTE). Disclosed is a method of operating a telecommunication system comprising a Radio Unit, RU, and a Distributed Unit, DU, having a fronthaul interface therebetween, wherein the method comprises the step of: optimising energy efficiency of the telecommunication system by selectively controlling a first number, a, of quantization bits associated with an Analog to Digital Convertor in the RU, and a second number, b, of compression bits associated with a Decompression function in the DU, by use of Reinforcement Learning.

### TECHNICAL FIELD

The present invention relates to a new interface for multi-user multiple-input multiple-output (MU-MIMO) Open Radio Access Networks (O-RAN) systems which allows the joint design of the number of quantization bits (a) and the number of compression bits (b) to maximize the total energy efficiency under fronthaul and quality of service (QoS) constraints. The energy efficiency optimization problem cannot be solved in the prior art by using known convex optimization methods. Embodiments use a reinforcement learning (RL) technique to handle the non-convexity issue.

### BACKGROUND ART

Considering the development of wireless communication from generation to generation, the technologies have been developed mainly for services targeting humans, such as voice calls, multimedia services, and data services. Following the commercialization of 5G (5th-generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th-generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collison avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

### DISCLOSURE OF INVENTION

### Technical Problem

The present disclosure relates to wireless communication systems and, more specifically, the present disclosure relates to joint fronthaul quantization and compression optimizer (JFQCO) for energy efficient O-RAN in a wireless communication system.

### Solution to Problem

It is an aim of embodiments of the present invention to address shortcomings in the prior art, whether mentioned herein or not.

According to the present invention there is provided an apparatus and method as set forth in the appended claims. Other features of the invention will be apparent from the dependent claims, and the description which follows.

According to a first aspect of the present invention, there is provided a method of operating a telecommunication system comprising a Radio Unit, RU, and a Distributed Unit, DU, having a fronthaul interface therebetween, wherein the method comprises the step of: optimising energy efficiency of the telecommunication system by selectively controlling a first number, a, of quantization bits associated with an Analog to Digital Convertor in the RU, and a second number, b, of compression bits associated with a Decompression function in the DU, by use of Reinforcement Learning.

In an embodiment, the step of optimising is performed either periodically according to a schedule or as a result of a specified threshold being reached.

In an embodiment, the threshold is related to either a data throughput on the fronthaul interface or a required Quality of Service,

$$Q O {S}_{k}^{req} .$$

In an embodiment, the energy efficiency is defined as:

$$EE ( a , b ) = \frac{B \cdot SE ( a , b )}{{P}_{Total} ( a , b )}$$

where B.SE(a, b) is sum spectral efficiency and P_{Total}(a, b) is total power consumed.

In an embodiment, an optimisation problem, P₁, related to EE is formulated:

$${P}_{1} : {max}_{a , {b}_{i}} EE ( a , b ) ,$$

$$s . t . 1 \leq a \leq 18 ,$$

$$1 \leq {b}_{i} \leq 8 ,$$

$$Q O {S}_{k} \geq Q O {S}_{k}^{req} , ∀ K$$

where EE denotes energy efficiency of the telecommunication system, QOSₖ refers to a quality of service at the kth user and

$$Q O {S}_{k}^{req}$$

is a required QoS at a kth user

In an embodiment, the optimisation is performed in a Joint Fronthaul Quantization and Compression Optimizer, JFQCO, located in a Service Management and Orchestration, SMO, function, remote from the RU and DU.

In an embodiment, the telecommunication system is an Open Radio Access Network, O-RAN, system, or a 3GPP system, such as 4G, 5G or 6G.

In an embodiment, the telecommunication system is controlled by one or more of a Service and Management Orchestrator, SMO, and a Near Real-Time RAN Intelligent Controller, Near RT-RIC.

According to a second aspect of the present invention, there is provided apparatus arranged to perform any one of the first aspect.

Embodiments of the present invention provide a joint fronthaul quantization and compression optimizer (JFQCO) for multiple-cell/multiple-user-equipment C-RAN architecture.

Using the OU-ADC, the performance of an O-RAN system with limited fronthaul links (for example copper links), is close to the performance of an O-RAN system with perfect fronthaul links (fibre links). The main reason for this is that the OU-ADC provides the lowest distortion error. Using the OU-ADC of an embodiment, it is possible to use fewer quantization bits, which improves the energy efficiency of the OU-ADC. Note that the more bits in use at the fronthaul links, the more energy will be consumed in the ORAN system. Therefore, embodiments of the invention make use of the available possible compression techniques, namely, Block Floating Point (BFP), Block Scaling (BS), and μ-Law, adopted by O-RAN specifications.

Embodiments of the invention simultaneously optimize the quantization bits and compression bits, by considering the energy efficiency in the O-RAN system.

Embodiments of the present invention provide a method performed by a joint fronthaul quantization and compression optimizer (JFQCO) producer in a service management and orchestration (SMO) entity, the method comprising: receiving, from a consumer in the SMO entity, a request for JFQCO attributes; as a response to the request for the JFQCO attributes, transmitting, to the consumer in the SMO entity, the JFQCO attributes including quantization attributes and at least one of ADC attributes or DCA attributes; and receiving, from the consumer in the SMO entity, a JFQCO new configuration associated with compression attributes based on a fronthaul optimization.

Embodiments of the present invention provide a method performed by consumer in a service management and orchestration (SMO) entity, the method comprising: transmitting, to a joint fronthaul quantization and compression optimizer (JFQCO) producer in the SMO entity, a request for JFQCO attributes; as a response to the request for the JFQCO attributes, receiving, from the JFQCO producer in the SMO entity, the JFQCO attributes including quantization attributes and at least one of ADC attributes or DCA attributes; and transmitting, to the JFQCO producer in the SMO entity, a JFQCO new configuration associated with compression attributes based on a fronthaul optimization.

Embodiments of the present invention provide a joint fronthaul quantization and compression optimizer (JFQCO) producer in a service management and orchestration (SMO) entity, the JFQCO producer comprising: a transceiver; and a controller coupled with the transceiver configured to: receive, from a consumer in the SMO entity, a request for JFQCO attributes; as a response to the request for the JFQCO attributes, transmit, to the consumer in the SMO entity, the JFQCO attributes including quantization attributes and at least one of ADC attributes or DCA attributes; and receive, from the consumer in the SMO entity, a JFQCO new configuration associated with compression attributes based on a fronthaul optimization.

Embodiments of the present invention provide a consumer in a service management and orchestration (SMO) entity, the consumer comprising: a transceiver; and a controller coupled with the transceiver configured to: transmit, to a joint fronthaul quantization and compression optimizer (JFQCO) producer in the SMO entity, a request for JFQCO attributes; as a response to the request for the JFQCO attributes, receive, from the JFQCO producer in the SMO entity, the JFQCO attributes including quantization attributes and at least one of ADC attributes or DCA attributes; and transmit, to the JFQCO producer in the SMO entity, a JFQCO new configuration associated with compression attributes based on a fronthaul optimization.

Although a few preferred embodiments of the present invention have been shown and described, it will be appreciated by those skilled in the art that various changes and modifications might be made without departing from the scope of the invention, as defined in the appended claims.

### Advantageous Effects of Invention

According to an embodiment of the disclosure, a wireless communication can be performed efficiently. Especially, a joint fronthaul quantization and compression optimizer (JFQCO) for energy efficient O-RAN can be performed efficiently.

### BRIEF DESCRIPTION OF DRAWINGS

For a better understanding of the invention, and to show how embodiments of the same may be carried into effect, reference will now be made, by way of example only, to the accompanying diagrammatic drawings in which:

FIG. 1 illustrates the quantization of an analog signal as known in the art;

FIG. 2 shows Table 1, an optimal step size of OU-ADC, for any quantization resolution values with “a=1 bit” up to “a=18 bits”;

FIG. 3 shows Table 2, which shows bit rate for various parameters;

FIG. 4 shows lower layer UL split description for LTE and NR as known in the art;

FIG. 5 shows o-RAN architecture known in the art;

FIG. 6 shows Joint Fronthaul Quantization and Compression Optimizer (JFQCO) for Energy Efficient O-RAN according to an embodiment of the invention;

FIG. 7a shows a block diagram illustrating a method where the rApp can choose to jointly optimize the fronthaul load with the ADC (DAC) quantization state according to an embodiment of the invention;

FIG. 7b shows a chart showing O-RAN current (prior art) specifications vs the dynamic choice between the existing O-RAN methods, according to an embodiment of the invention;

FIG. 8 shows an example of Frontal optimizing jointly the Quantization and Compression procedure according to an embodiment of the invention; and

FIG. 9 shows an alternative embodiment of the present invention.

### MODE FOR THE INVENTION

The common public radio interface (CPRI) specification was published by a union of radio equipment manufacturers, aiming to standardize the fronthaul communication of Radio Unit (RU) and Distributed Unit (DU) in multiple user-multiple input multiple output (MU-MIMO) open radio access network (O-RAN). In common public radio interface (CPRI), each sample is quantized exploiting a given large number of bits (around 15 bits) per sample. It is reasonable to assume, however, that the fronthaul network will carry quantized signals, at least in the uplink direction, and that this will affect the network performance. This fronthaul limitation (limited capacity links from the RUs to the DU) is a more difficult challenge on the uplink as, in the downlink mode, the signals are sent as bit streams to the RUs which then apply local modulation and coding. However, the fronthaul links send the quantized version of the received signals at the RUs to the DU, which introduces additional self-interference to the signals at the DU.

Providing better rate efficiency and node scalability for the Fifth Generation (5G) requirement to increase capacity by utilizing new spectrum and beamforming radios, while also providing more deployment flexibility maintained to reduce network cost by taking in account the variety of novel use cases, has led to new splits in the RAN protocol stack where more baseband functionality was moved into the radio and the new Ethernet based eCPRI interface was introduced.

As a result, a better rate efficiency and node scalability can be achieved in 5G/5G+. In addition, the O-RAN suggests optional IQ compression blocks to transport the IQ samples over the fronthaul efficiently, where in the prior art O-RAN specification, a given number of Physical Resource Blocks (PRBs) are compressed with the same compression method in each cell section. Furthermore, depending on the signal power, the performance of the compression methods can vary significantly and various PRBs should be compressed with a single compression method according to the O-RAN specification. As a result, the compressed PRBs with different power levels and iqWidth (assuming 1 bit≤iqWidth≤8 bits) may have different levels of signal-to-quantization-noise ratio (SQNR).

A problem, therefore, is optimising the compression of the IQ symbols signals to solve as a multi-objective optimisation problem that achieves maximum energy efficiency for multiple-cell/multiple-user-equipment (UE) cellular deployment following a cloud radio access network (C-RAN) architecture. Additionally, the Analog to Digital Convertor/Digital to Analog Convertor (ADC/DAC) are configurable and the number of bits and quantization steps are vital in improving the system performance, especially at the digital processing unit inside the O-RU.

Lastly, Sixth Generation (6G) technology should include a flexible approach by allowing the control of O-RAN components efficiently such as the O-RU and Fronthaul signal processing using advance machine learning that the rApps and xApps can run and maintain in the Non (Real)-Time Intelligent Radio Access Network. This should lead the way to a full automated wireless network in the future.

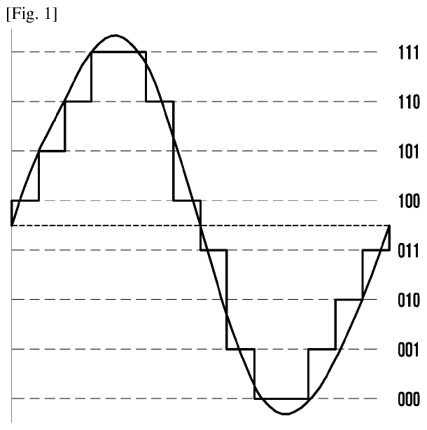

Unfortunately, high-speed, high-resolution, ADCs are costly and power-hungry for portable devices. Whether it is high-speed and large bandwidth communication system, mm Wave system or massive MIMO system, from the point of solving power assumption bottleneck, a low-resolution quantized receiver is one of the most promising direct ways to realize high energy efficiency. FIG. 1 shows how an analog signal gets quantized. The smooth line represents the analog signal while the stepped line represents the quantized signal.

A new approach has been proposed for the analysis of the effect of fronthaul quantization on ORAN systems. Here for simplicity (and hence improved scalability) a uniform ADC is assumed. The optimal uniform ADC (OU-ADC) can be used in fronthaul of the ORAN systems.

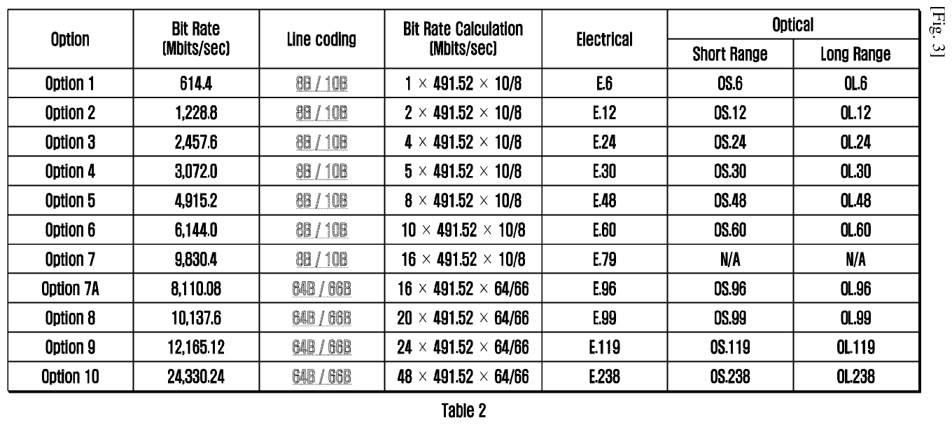

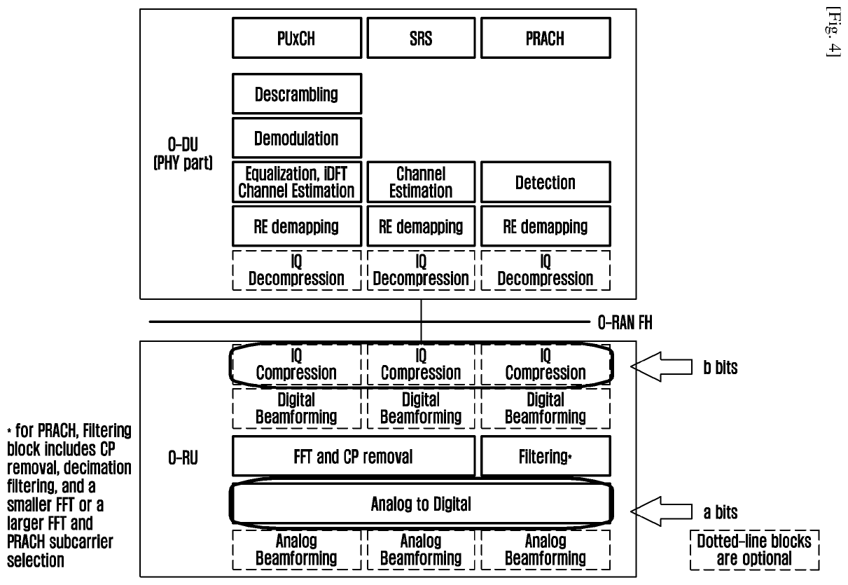

Embodiments of the invention, provide an optimal uniform quantizer function (with the pre-defined optimal step size of the quantizer). By exploiting the OU-ADC and only a few bits to quantize the input signal, the performance of an ORAN system with copper links is close to the performance of an ORAN system with fibre links. UL functional split for various physical layer channels and transmission modes are illustrated in FIG. 4. Likewise, digital beamforming in this context, is a function of antenna port selection or antenna port combining. Note that the output of the ADC of FIG. 1 is equivalent to the input plus distortion noise (quantization error). The optimal step size of the quantizer is obtained by solving the signal-to-distortion noise ratio (SDNR) maximization problem. As the SDNR maximization problem is optimally solved for a Uniform ADC, the quantization error (or distortion error) is the minimum possible value using the OU-ADC. The optimal step size of OU-ADC, for any quantization resolution values with “1 bit” up to “18 bits” can be obtained. Based on Bussgang's theorem, a nonlinear output of a quantizer can be represented as a linear function as follows:

$$Q ( z ) = f ( z ) = α z + {n}_{d} , ∀ k ,$$

where α is a constant value and n_{d} refers to the distortion noise which is un-correlated with the input of the quantizer, z. CPRI support multiple levels of discrete throughput depending on various options that are summarized in Table 2 shown in FIG. 3. Note that the number of bits, a, to quantize the received signal is given by:

$$a ∝ \frac{Bit Race \times {T}_{c}}{N \times ( K + {τ}_{f} )} ,$$

where Bit Rate is provided in second column of Table 2, shown in FIG. 3, T_{c} is coherence time of channel, N is number of antennas at the RUs. Moreover, K and τ_{f} refer to the number of user devises in the environment and the length of frame (which represents the length of the uplink data), respectively. Moreover, note that τ_{f}=τ_{c}−τₚ, denotes the number of samples for each coherence interval. Moreover, τₚ is the number of uplink pilot. Note that based on LTE, the coherence time is about 1 millisecond.

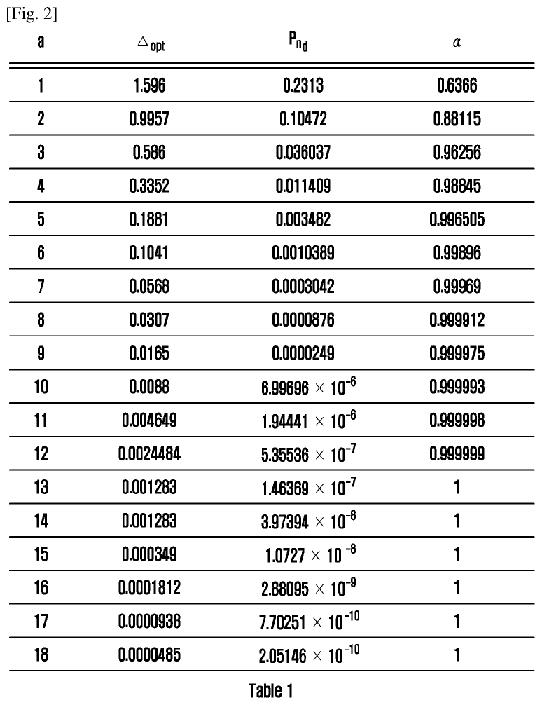

In embodiments of the invention, a single cell is assumed, when only one base station supports multiple users. All users are served at the same time and same frequency. Note that the neighboring cells are controlled by different base stations or eNodeBs, and inter-cell interference (ICI) is managed by coordination. Note that the values α and power of the distortion noise, i.e., pₙ_{_{d}} are provided in Table 1 shown in FIG. 2. Next, the received signal for the kth user after using linear detector (LD) at the O-RU is given by

Received Signalₖ=LDₖQ(yᵣ)

where Q(yᵣ) is the quantized version of the received signal yᵣ. Moreover, LD_{K} is the linear precoding at the O-RU, which is designed to remove inter-user-interference (IUI). On the other hand, in 3GPP systems, the receiver characteristics are specified at the Base Station (BS) antenna connector (test port A) with a full complement of transceivers for the configuration in normal operating conditions. If any external apparatus such as a receiver amplifier, a filter or the combination of such devices is used, the BS radio reception requirements apply at the far end antenna connector (port B). Moreover, most of the receiver characteristics such as reference sensitivity power level, Dynamic range, In-channel selectivity, blocking and receiver intermodulation have minimum requirement for the E-UTRA that the throughput shall be ≥95% of the maximum throughput of the reference measurement channel in addition to other requirements. However, the effect of the number of quantization bits (i.e., a in Table 1, FIG. 2) is not yet explicitly included.

Moreover, to reduce the load on the fronthaul network and hence save more energy, three possible compression techniques such as Block Floating Point (BFP), Block Scaling (BS), and μ-Law are adopted by O-RAN specifications. With new research fields that RAN splitting opens, different compressions schemes for the O-RAN fronthaul interface, also considering multi-stream capabilities typical of MIMO setups have been discussed. FIG. 4 illustrates the O-RAN lower layer split (O-RAN_{7.2}) with a and b bits for quantization and compression, respectively.

Embodiments of the invention approach the problems referred to previously by taking into consideration both ADC/DAC and IQ samples (Modulation) compression/decompression parameters to optimize the energy efficiency dynamically.

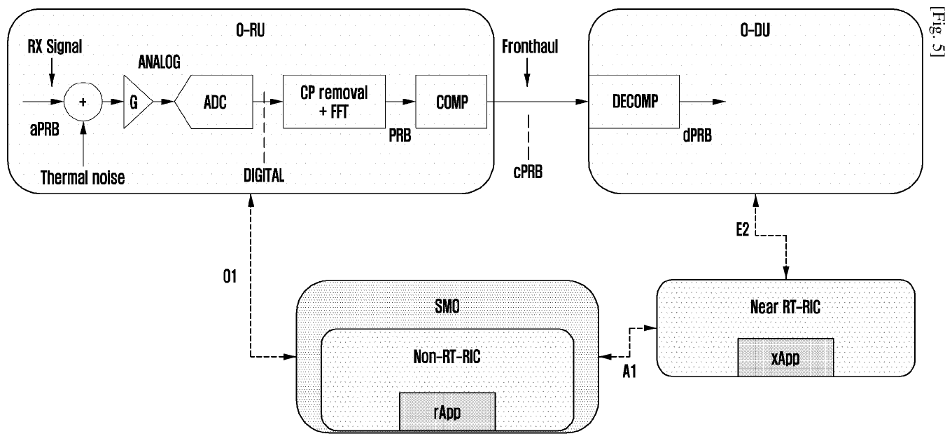

FIG. 5 demonstrates the prior art O-RAN architecture, where the SMO contains the non-real time RIC that hosts the intelligent rApps. Embodiments of the invention exploit a novel OU-ADC in Fronthaul between any the O-RU and O-DU entities, via the optimal step size, for any quantization resolution (bits) values with “1 bit” up to “18 bits”. Embodiments also exploit optimal compression in O-RAN systems. To make this possible, for a given OU-ADC, the number of quantization bits (a) for the O-RU ADC is optimized. Also, the compression scheme is optimized and the corresponding number of bits (bᵢ), where i is scheme 1, 2 or 3. Jointly the IQ sample compression scheme can be chosen dynamically according to the fronthaul load status.

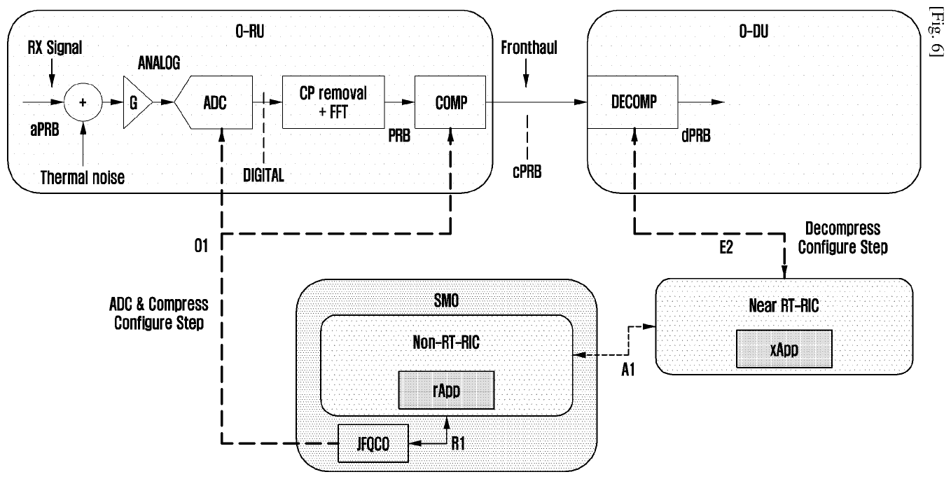

The joint fronthaul quantization and compression optimizer (JFQCO) of an embodiment is presented in FIG. 6, where the “ADC & Compress Configure Step” and “Decompress Configure Step” are novel interfaces to implement a JFQCO. The JFQCO uses any one or any combination of the O-RAN interface(s) (O1, E2, FH) to configure the ADC (DCA and/or the (DE) COMP components.

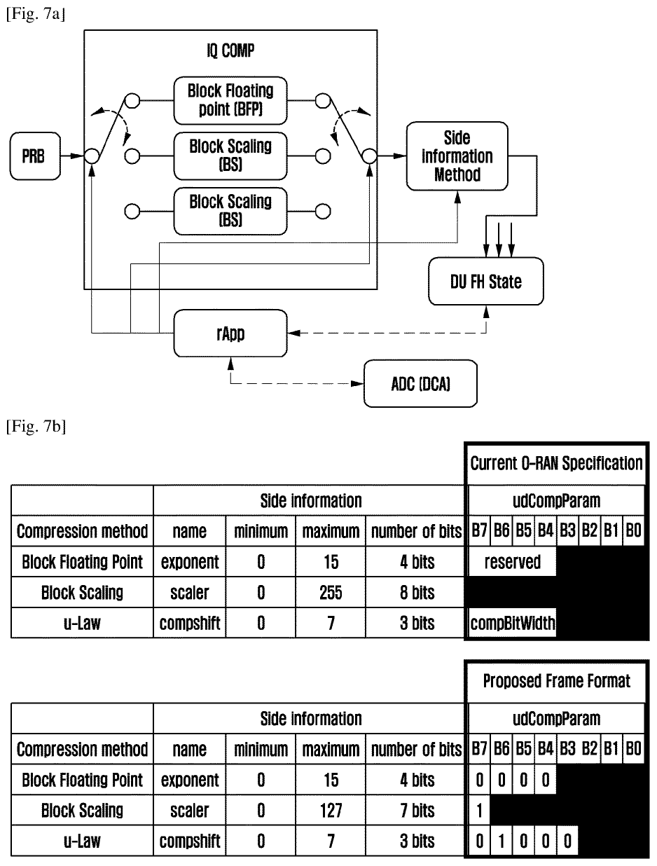

Next, the block diagram for best method the rApp can choose to jointly optimize the fronthaul load with the ADC (DCA) quantization state in shown in FIG. 7(a). Moreover, FIG. 7(b) illustrates the O-RAN current specifications vs the dynamic choice between the existing O-RAN methods.

The operational steps of an embodiment of the invention are explained below:
Step 1: Request the profile of Fronthaul. This gives Bit Rate from Table 2, FIG. 3.
Step 2: Response for assuming ADC/DAC Management Service producer
Step 3: IQ compression/decompression MnS producer
Step 4: AI/ML MnS producer/consumer
Step 5: Proposed Joint Fronthaul Quantization and Compression Optimizer (JFQCO) KPI MnS producer (herein, the following are considered KPIs: number of O-RUs the FH supports, the consumed energy per (a+b) bits). Note that a preferred KPI is energy efficiency.

The a, b elements of the users by are designed by considering the energy efficiency in the O-RAN system. By definition, the total energy efficiency is achieved by dividing the sum spectral efficiency by the total consumed power given by:

$$EE ( a , b ) = \frac{B \cdot SE ( a , b )}{{P}_{Total} ( a , b )}$$

where, EE(a,b) shows that the EE is a function of quantization and compression bits a and b respectively. The optimization problem of EE can be formulated:

$${P}_{1} : {max}_{a , {b}_{i}} EE ( a , b ) ,$$

$$s . t . 1 \leq a \leq 18 ,$$

$$1 \leq {b}_{i} \leq 8 ,$$

$$Q O {S}_{k} \geq Q O {S}_{k}^{req} , ∀ K$$

Where the term EE denotes energy efficiency of the O-RAN system. Moreover, QOSₖ refers to the quality of service (QoS) at the kth user and

$$Q O {S}_{k}^{req}$$

is the “required QoS” at the kth user. As a reminder, note that at the receiver, the throughput shall be ≥95% of the maximum throughput of the reference measurement channel specified. The energy efficiency of the O-RAN system can be defined as follows:

$$EE = \frac{SE}{{P}_{Total}}$$

where P_{Total} is the total power consumption and can be defined as follows: P_{Total}=P_{TX}+P_{CP}, where P_{TX} is the uplink power amplifiers (PAs) due to transmit power at the users and PA dissipation, and P_{CP} refers to the circuit power (CP) consumption. The power consumption P_{TX} is given by

$${P}_{TX} = \frac{{\sum }_{k = 1}^{K} {P}_{k}}{ξ} ,$$

where ξ is the PA efficiency at each user. The power consumption P_{CP} is obtained as

$${P}_{CP} = {RP}_{Fix} + {KP}_{U} + {\sum }_{r = 1}^{R} {P}_{FH , r} + {\sum }_{r = 1}^{R} {P}_{COMP , r} ,$$

where P_{Fix} is a fixed power consumption (including control signals and fronthaul) at each O-RU, P_{U} denotes the required power to run circuit components at each user and finally, fronthaul power consumption from the rth O-RU to the CPU is obtained as follows:

$${P}_{FH , r} = {P}_{FT , r} \frac{{R}_{FH , r}}{{C}_{FH , r}} ,$$

where P_{FT,r} is the power required for fronthaul traffic (FT) at the rth O-RU, and C_{FH,r} introduces the capacity of the fronthaul link between the rth O-RU and the O-DU. Moreover, P_{COMP,r} is the power consumption for compression at the rth O-RU.

The coherence time of channel correlation matrix is the factor for updating the ADC/DAC configuration update which takes around 3.2 seconds. At the beginning of the coherence time of the channel correlation matrix, the optimization problem is solved and the optimal number of bits a and b are fixed.

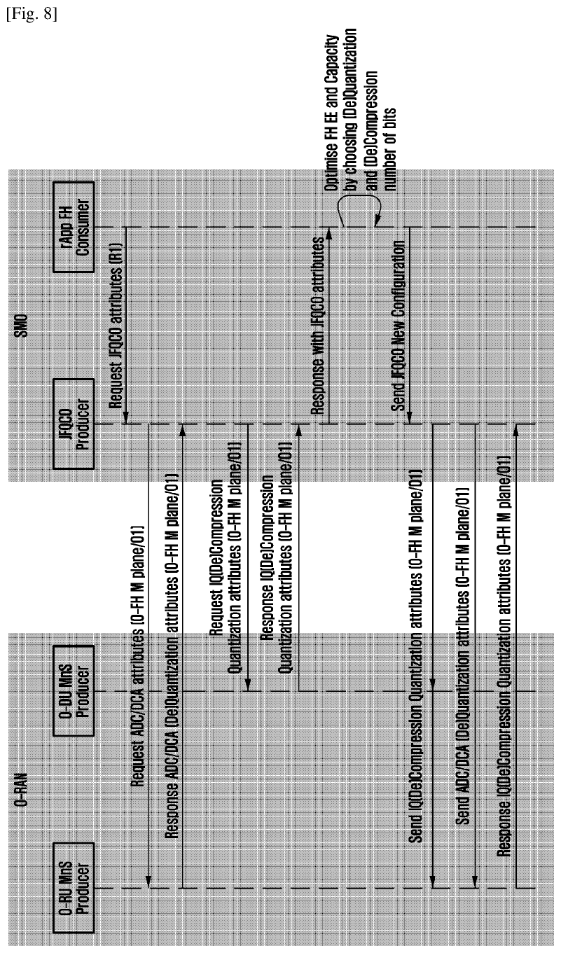

In FIG. 8, the procedure starts with the rApp in the Service Management and Orchestration (SMO) function requesting the attributes from the O-RU (e.g., α, Δ, a etc.) with the O-RU responding by sending a message with the attributes to the rApp. After that, the rApp in the SMO requests the attributes from the O-DU (e.g. μ-law, b bits, etc.) and the O-DU responds by sending a message with the attributes to the rApp.

Then, the rApp optimizes the fronthaul and sends an action policy to the O-DU and the O-RU to configure the (De)Compression attributes with the new b bits for compression. After that, the SMO sends the action policy for the O-RU to configure the ADC/DAC attributes with the new a bits for quantization.

There are different kind of quantizers than those described so far. An approach in C-RAN exploits Wyner-Ziv coding. The coding scheme at the Remote Radio Heads (RRHs) in order to leverage the side information at the receiver is known as Wyner-Ziv coding. Using Wyner-Ziv quantization, the RRH can exploit a better quantizer with an improved resolution without any need to increase the fronthaul rate. Another technique in C-RAN is compute-and-forward, which is originated from network information theory and nested lattice codes. Many of the network information theoretical problems for the design of C-RANs remain open and further developments in this domain may provide progress in the field of C-RAN technology.

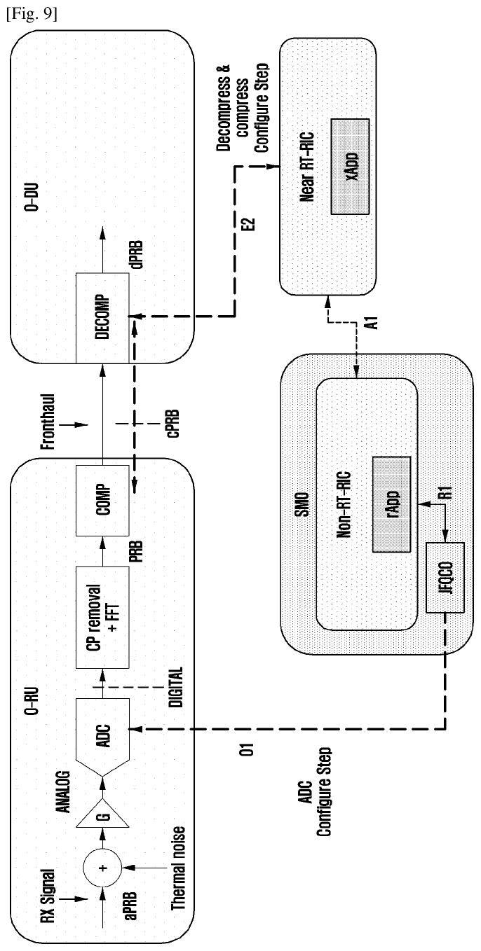

A further embodiment provides an alternative implementation for JFQCO using an xApp for a faster controlling loop for JFQCO, through the fronthaul, to change the IQ compression method. This alternative implementation for JFQCO is shown in FIG. 9. In this embodiment, the JFQCO is provided between the SMO and the O-RU, as shown.

In the foregoing, the various embodiments make use of an rApp in the SMO as well as an xApp in the Near RT-RIC. It should be noted that the rApp provides a slower process, whereas the xApp is near real time. By use of the two together, it is possible to better optimise the system for both slow and fast hanging scenarios. However, it is possible to implement an embodiment of the invention using only the xApp or only the rApp as deemed appropriate in a particular installation. The various interfaces shown in e.g. FIG. 9 require adjusting if only one of the xApp or rApp is used, but the skilled person is able to configure this as required.

In the event that only an xApp is provided, then the JFQCO may be located in the Near RT RIC.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method performed by a joint fronthaul quantization and compression optimizer (JFQCO) producer, the method comprising:
receiving, from a consumer within a non-real-time radio access network (RAN) intelligent controller (Non-RT RIC) or a near real-time RAN intelligent controller (Near-RT RIC), a request for JFQCO attributes;
as a response to the request for the JFQCO attributes, transmitting, to the consumer, the JFQCO attributes including quantization attributes and at least one of ADC attributes or DCA attributes; and
receiving, from the consumer, a JFQCO new configuration associated with compression attributes based on a fronthaul optimization.

2. The method of claim 1
wherein the quantization attributes are associated with an analog to digital convertor (ADC) in a radio unit (RU), and
wherein the compression attributes are associated with a decompression function in a distributed unit (DU).

3. The method of claim 1,
wherein the fronthaul optimization is associated with energy efficiency (EE) defined as
$$EE ( a , b ) = \frac{B . S E ( a , b )}{{P}_{Total} ( a , b )}$$
where B.SE(a, b) is sum spectral efficiency and P_{Total}(a, b) is total power consumed, and
wherein the EE is associated with fronthaul IQ (de)compression in RU/DU a ADC quantization in RU.

4. The method of claim 3,
wherein an optimisation problem, P₁, related to the EE is formulated:
$${P}_{1} : {max}_{a , {b}_{i}} EE ( a , b ) ,$$
$$s . t . : 1 \leq a \leq 18 ,$$
$$1 \leq {b}_{i} \leq 8 ,$$
$$Qo {S}_{k} \geq {QoS}_{k}^{r e q} , ∀ K$$
where the EE denotes energy efficiency of a telecommunication system, QoSₖ refers to a quality of service at a kth user and
$${QoS}_{k}^{r e q}$$
is a required QoS at the kth user.

5. A method performed by a consumer within a non-real-time radio access network (RAN) intelligent controller (Non-RT RIC) or a near real-time RAN intelligent controller (Near-RT RIC), the method comprising:
transmitting, to a joint fronthaul quantization and compression optimizer (JFQCO) producer, a request for JFQCO attributes;
as a response to the request for the JFQCO attributes, receiving, from the JFQCO producer, the JFQCO attributes including quantization attributes and at least one of ADC attributes or DCA attributes; and
transmitting, to the JFQCO producer, a JFQCO new configuration associated with compression attributes based on a fronthaul optimization.

6. The method of claim 5,
wherein the quantization attributes are associated with an analog to digital convertor (ADC) in a radio unit (RU), and
wherein the compression attributes are associated with a decompression function in a distributed unit (DU).

7. The method of claim 5,
wherein the fronthaul optimization is associated with energy efficiency (EE) defined as
$$E E ( a , b ) = \frac{B . S E ( a , b )}{{P}_{Total} ( a , b )}$$
where B.SE(a, b) is sum spectral efficiency and P_{Total}(a, b) is total power consumed, and
wherein the EE is associated with fronthaul IQ (de)compression in RU/DU a ADC quantization in RU.

8. The method of claim 7,
wherein an optimisation problem, P₁, related to the EE is formulated:
$${P}_{1} : {max}_{a , {b}_{i}} EE ( a , b ) ,$$
$$s . t . : 1 \leq a \leq 18 ,$$
$$1 \leq {b}_{i} \leq 8 ,$$
$$Qo {S}_{k} \geq {QoS}_{k}^{r e q} , ∀ K$$
where the EE denotes energy efficiency of a telecommunication system, QoSₖ refers to a quality of service at a kth user and
$${QoS}_{k}^{r e q}$$
is a required QoS at the kth user.

9. A joint fronthaul quantization and compression optimizer (JFQCO) producer comprising:
a transceiver; and
a controller coupled with the transceiver configured to:
receive, from a consumer within a non-real-time radio access network (RAN) intelligent controller (Non-RT RIC) or a near real-time RAN intelligent controller (Near-RT RIC), a request for JFQCO attributes;
as a response to the request for the JFQCO attributes, transmit, to the consumer, the JFQCO attributes including quantization attributes and at least one of ADC attributes or DCA attributes; and
receive, from the consumer, a JFQCO new configuration associated with compression attributes based on a fronthaul optimization.

10. The JFQCO producer of claim 9
wherein the quantization attributes are associated with an analog to digital convertor (ADC) in a radio unit (RU), and
wherein the compression attributes are associated with a decompression function in a distributed unit (DU).

11. The JFQCO producer of claim 9,
wherein the fronthaul optimization is associated with energy efficiency (EE) defined as
$$EE ( a , b ) = \frac{B . S E ( a , b )}{{P}_{Total} ( a , b )}$$
where B.SE(a, b) is sum spectral efficiency and P_{Total}(a, b) is total power consumed, and
wherein the EE is associated with fronthaul IQ (de)compression in RU/DU a ADC quantization in RU.

12. The JFQCO producer of claim 11,
wherein an optimisation problem, P₁, related to the EE is formulated:
$${P}_{1} : {max}_{a , {b}_{i}} EE ( a , b ) ,$$
$$s . t . : 1 \leq a \leq 18 ,$$
$$1 \leq {b}_{i} \leq 8 ,$$
$$Qo {S}_{k} \geq {QoS}_{k}^{r e q} , ∀ K$$
where the EE denotes energy efficiency of a telecommunication system, QoSₖ refers to a quality of service at a kth user and
$${QoS}_{k}^{r e q}$$
is a required QoS at the kth user.

13. A consumer within a non-real-time radio access network (RAN) intelligent controller (Non-RT RIC) or a near real-time RAN intelligent controller (Near-RT RIC), the consumer comprising:
a transceiver; and
a controller coupled with the transceiver configured to:
transmit, to a joint fronthaul quantization and compression optimizer (JFQCO) producer, a request for JFQCO attributes;
as a response to the request for the JFQCO attributes, receive, from the JFQCO producer, the JFQCO attributes including quantization attributes and at least one of ADC attributes or DCA attributes; and
transmit, to the JFQCO producer, a JFQCO new configuration associated with compression attributes based on a fronthaul optimization.

14. The consumer of claim 13,
wherein the quantization attributes are associated with an analog to digital convertor (ADC) in a radio unit (RU), and
wherein the compression attributes are associated with a decompression function in a distributed unit (DU).

15. The consumer of claim 13,
wherein the fronthaul optimization is associated with energy efficiency (EE) defined as
$$E E ( a , b ) = \frac{B . S E ( a , b )}{{P}_{Total} ( a , b )}$$
where B.SE(a, b) is sum spectral efficiency and P_{Total}(a, b) is total power consumed,
wherein the EE is associated with fronthaul IQ (de)compression in RU/DU a ADC quantization in RU, and
wherein an optimisation problem, P₁, related to the EE is formulated:
$${P}_{1} : {max}_{a , {b}_{i}} EE ( a , b ) ,$$
$$s . t . : 1 \leq a \leq 18 ,$$
$$1 \leq {b}_{i} \leq 8 ,$$
$$Qo {S}_{k} \geq {QoS}_{k}^{r e q} , ∀ K$$
where the EE denotes energy efficiency of a telecommunication system, QoSₖ refers to a quality of service at a kth user and
$${QoS}_{k}^{r e q}$$
is a required QoS at the kth user.
